(19) United States
(12) Patent Application Publication
(10) Pub. No.: US 2023/0306545 A1
(43) Pub. Date: Sep. 28, 2023

(54) PREDICTIVE CASE SOLVABILITY SCORE SYSTEM WITH ACTION RECOMMENDATIONS BASED ON DETECTED TRENDS

(71) Applicant: MOTOROLA SOLUTIONS, INC., Chicago, IL (US)

(72) Inventors: FRANCESCA SCHULER, PALATINE, IL (US); CHAD ESPLIN, MENDON, UT (US); BRIAN PUGH, DRAPER, UT (US); TRENT J. MILLER, WEST CHICAGO, IL (US); STEVEN D. TINE, CHESHIRE, CT (US); PIETRO RUSSO, MELROSE, MA (US)

(21) Appl. No.: 17/656,342

(22) Filed: Mar. 24, 2022

(51) Int. Cl. G06Q 50/26

(52) U.S. Cl. CPC G06Q 50/26

(57) ABSTRACT

Technical methods, devices, and systems disclosed herein provide a predictive case-solvability score service. The predictive case-solvability score service generates case solvability scores for cases, detects events that signal those scores should be updated, updates a machine-learning model over time to ensure current trends in recent data are reflected, and identifies specific actions to recommend for increasing those scores. Furthermore, the predictive case-solvability score service provides an interface that allows users to perceive trends in case-solvability scores over time and to execute some of the specific recommended actions.

### BACKGROUND

Law-enforcement agencies generally have to investigate multiple cases in parallel. The nature of the cases that an agency is handling at any given time may vary widely. Some cases may be solved relatively quickly, while others may go cold and remain unsolved for decades until new evidence is found or technology improves to a point where new leads can be found using old evidence. Many modern software applications can greatly assist agents in solving cases. For example, digital technology allows documents and images to be reproduced and distributed quickly and easily. Computers can perform computationally intensive tasks, such as comparing a digitized fingerprint to a large collection of digitized fingerprints via computer-vision techniques or comparing a sample of deoxyribonucleic acid (DNA) to a large collection of DNA samples to find a match, with much greater speed and accuracy than humans. Furthermore, the Internet and other computing networks enable users to execute searches of remote data repositories in a matter of seconds or minutes without traveling to the actual sites of those data repositories. Modern software also allows agents to generate realistic models and simulations for inferring how crimes may have occurred and to perform other tasks that facilitate solving cases.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 illustrates a computing environment in which systems described in the present disclosure can operate, according to one example.

FIG. 2 illustrates one example of how a user interface for systems described herein may appear on an electronic display, according to one example.

FIG. 3 illustrates functionality for a predictive case-solvability service, according to one example.

FIG. 4 illustrates a predictive case-solvability system that generates solvability scores when trigger events are detected, identifies actions to recommend when solvability scores cause conditions to be satisfied, and updates a machine-learning model used to generate solvability scores, according to one example.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Since agencies and individual agents are often investigating multiple cases concurrently, agents are often obliged to determine how likely a case is to be solved so that cases can be prioritized in a manner that ensures the right amount of resources (e.g., personnel hours and agency money) will be assigned to each case. Some investigators evaluate cases using a static list of solvability factors (e.g., a solvability matrix) and try to set priorities and assign resources based on the evaluation. However, any estimate of a case's solvability is likely to obsolesce very quickly as evidence is collected, tips are received, leads are followed, and time passes in general. For example, witnesses who are initially cooperative may recant their initial statements or even disappear before providing any statements at all. Anonymous tips that initially seemed promising may prove to be hoaxes or dead ends. Valuable evidence may be accidentally contaminated. Events such as these are not uncommon in many types of cases.

Furthermore, extrinsic factors such as medical knowledge, laws, and technology that evolve at unpredictable rates over time may strongly influence case solvability. The discovery of polymerase chain reaction (PCR), for example, made it possible to amplify previously unusable trace amounts of deoxyribonucleic acid (DNA) into quantities that could be used for searches against databases of potential offenders. In addition, the rapid growth of many genealogical databases in recent years has made forensic genealogy a viable approach for solving cases in which DNA from a crime scene does not directly match any known offenders.

Other changes, though, may reduce case solvability. Newly discovered differential diagnoses for conditions once thought to be pathognomonic for certain forms of criminal battery may reduce the solvability of a case (e.g., it is now known that glutaric aciduria type I can cause injuries once thought to be pathognomonic for abusive shaking in infants). Newly published scientific research may call the reliability of common investigative techniques (e.g., polygraph testing and the use of facial recognition software) into question. The law in a particular jurisdiction may change suddenly, thereby making certain types of evidence inadmissible or more difficult to obtain. For example, a new ruling in a criminal case may lower the bar for what is considered coercion during an interrogation. A new statute may raise the evidentiary standard that must be met before a search warrant can be issued.

Law-enforcement agencies are often subject to tight budget constraints. As a result, it may not be possible to assign a sufficient number of personnel hours to the task of updating case-solvability scores each time an event that might influence the probability of a case being solved occurs. Furthermore, even if sufficient personnel hours were available, the scoring rubric would have to be reevaluated and updated very frequently as technology, scientific knowledge, and laws evolve over time. Given the large number of factors that may affect case solvability, the complexity of developing such a rubric and keeping it up to date would not be trivial. Furthermore, even if such a complicated rubric could be miraculously designed and kept up to date, a mere rubric would lack the active capacity to identify specific actions that could be taken to increase the solvability of any given case. These challenges may render it impractical to rely on human effort and intuition alone to prognosticate case solvability with an acceptable level of accuracy and to identify actions that could be taken to increase case solvability.

The ever-changing domain of predicting case solvability is similarly challenging for computer software. While computers have the advantage of being able to retain and process a much larger volume of data than humans, computers generally have to be explicitly programmed to perform desired tasks. In a domain in which the relationship between of hundreds of parameters (e.g., factors that influence case solvability) and a desired output (e.g., a case-solvability score and a recommended action) is in a near-constant state of flux, a static solution implemented in computer software for predicting a case-solvability score and recommending actions to increase that score may become obsolete overnight. It may be impractical or prohibitively expensive to rewrite software code to update or replace algorithms and reconfigure parameter sets each time a disruptive new technology emerges, medical knowledge evolves, new scientific research casts doubt on existing evidentiary assumptions, and changes to the law happen—particularly if an entirely new prediction algorithm has to be derived and tested for accuracy before implementation.

The challenges listed above and other challenges present non-trivial obstacles for which no satisfactory software solution is currently available to agencies. Thus, there exists a need for enhanced technical methods, devices, and systems for generating case solvability scores, detecting events that signal those scores should be updated, updating the methodology for determining those scores over time to ensure current trends in recent data are reflected, and identifying specific actions to recommend for increasing those scores based on the detected trends. Furthermore, there exists a need for an interface that allows users to perceive trends in case-solvability scores over time, to consume the output of these technical methods, devices, and systems, and to execute the actions recommended thereby.

Further advantages and features consistent with this disclosure will be set forth in the following detailed description, with reference to the figures.

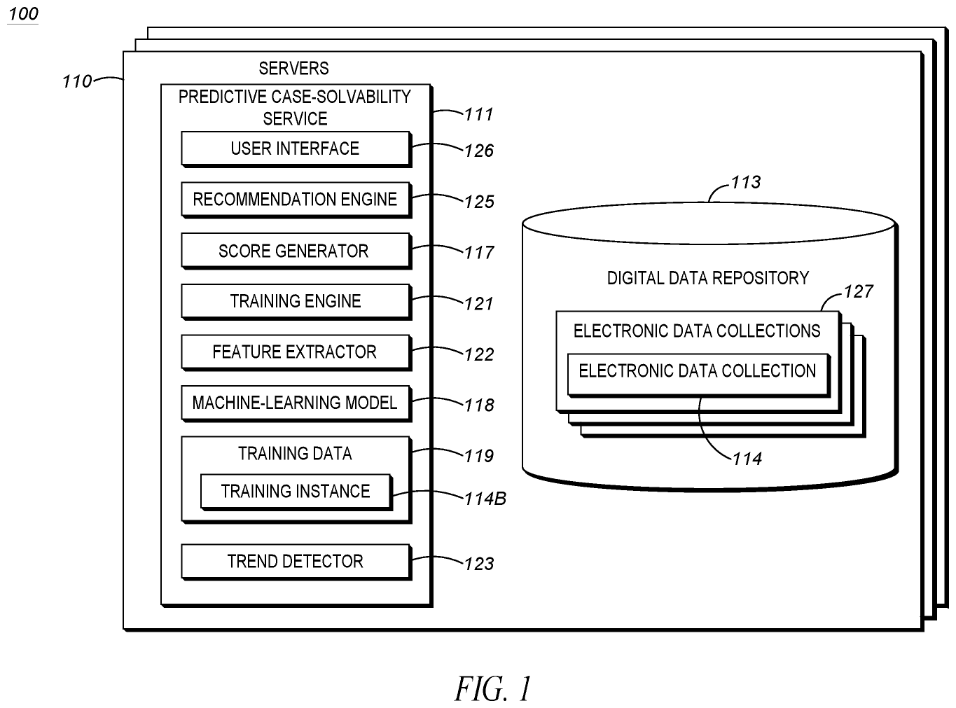

Referring now to the drawings, FIG. 1 illustrates a computing environment 100 in which systems described in the present disclosure can operate, according to one example. As shown, the computing environment 100 includes servers 110 that execute a predictive case-solvability service 111. The predictive case-solvability service 111 may be provided to a case-handling consumer entity (e.g., a law-enforcement agency or a private detective agency) to provide functionality that uses a score generator 117 to generate solvability scores for cases of interest and uses a recommendation engine 125 to recommend actions for the entity to perform to increase the likelihood that those cases will be solved. One or both of the recommendation engine 125 and the score generator 117 may leverage a machine-learning model 118 to accomplish these tasks. Furthermore, the predictive case-solvability service 111 uses a trend detector 123 to detect trigger events related to cases that may cause the solvability scores for those cases to change and updates the solvability scores accordingly. In addition, the predictive case-solvability service 111 updates the training data 119 when cases are solved and when cases go cold and periodically re-trains the machine-learning model 118 to ensure that the machine-learning model 118 is updated frequently. Furthermore, the predictive case-solvability service 111 plots solvability scores against time in a user interface 126 to illustrate solvability-score trends over time and allows a user to reassign cases through clicking and dragging solvability-score series to agent names. The components of the predictive case-solvability service 111 and the functions performed thereby will be discussed in greater detail below.

Persons of skill in the art will understand that any functionality attributed to the servers 110 or the blocks shown therein may be executed using computing resources such as processors, memory, network interconnects, and storage that are distributed across multiple sites (e.g., in a cloud computing platform) and are interconnected via a data center network, an enterprise network, a local area network (LAN), a virtual private network (VPN), or some other type of digital communication network (or a combination thereof). Persons of skill in the art will understand that the predictive case-solvability service 111 may represent a set of many different software modules that are configured to perform the functions described herein. Also note that functionality attributed to the predictive case-solvability service 111 or any block shown therein may also be performed by software modules that are separate from the predictive case-solvability service 111 and are merely in communication therewith without departing from the spirit and scope of this disclosure. Persons of skill in the art will further understand that solvability scores as described herein may be quantitative (e.g., a probability ranging from zero to one) or qualitative (e.g., categorical).

As shown, the predictive case-solvability service 111 may include a user interface 126, the recommendation engine 125, the score generator 117, a training engine 121, a feature extractor 122, a machine-learning model 118, and training data 119. The digital data repository 113 may include electronic data collections 127 that are associated with cases. As used herein, the term “case” refers to a matter (e.g., a crime) being investigated or otherwise handled by an entity (e.g., a law-enforcement agency or a private investigator) for the purpose of solving the case (e.g., by identifying the party responsible for committing a crime with sufficient evidence to satisfy a specific evidentiary standard such as by a preponderance of the evidence, by clear and convincing evidence, or beyond a reasonable doubt).

In one example, each of the electronic data collections 127 is a digital case file associated with a respective case. In this example, note that an electronic data collection (e.g., a digital case file) may include a plurality of files of many different types that are stored in many different formats. For example, an electronic data collection may include video data (e.g., digital footage from dashboard cameras, body cameras, security cameras, or smartphone cameras), audio data (e.g., digital audio recordings from 9-1-1 calls and undercover telephone conversations recorded via wiretapping), image data (e.g., digital photos of crime scenes, digital photos of items of physical evidence collected from crime scenes and via search warrants, autopsy photos, mug shots, and fingerprint images), textual data (e.g., transcriptions of audio conversations, descriptions of physical evidence, transcriptions of video data, incident reports, witness statements, email correspondence, results of chemical tests, results of spectroscopy tests, and reports from the Combined Deoxyribonucleic Acid (DNA) Index System (CODIS)), and data found on hard drives or flash drives confiscated from suspects. Furthermore, an electronic data collection may comprise many types of metadata (e.g., a case type for an associated case, such as robbery, homicide, grand theft auto, trespassing, battery, assault, fraud, shoplifting, theft, burglary, larceny, arson, embezzlement, insider trading, vandalism, bribery, perjury, extortion, tax evasion, etc.).

The examples of data types and case types listed above are merely illustrative and do not constitute an exhaustive list of case types or of data types that may be stored in an electronic data collection. Persons of skill in the art will recognize that many other case types and data types may be stored without departing from the spirit and scope of this disclosure. Also, for clarity in illustration, the digital data repository 113 is shown as a single block. However, persons of skill in the art will recognize that the digital data repository 113 may be spread across many different geographical locations. Note that the digital data repository 113 may be stored on a combination of non-volatile storage elements (e.g., disc drives, removable memory cards or optical storage, solid state drives (SSDs), network attached storage (NAS), or a storage area-network (SAN)). Furthermore, data stored in the digital data repository 113 may be stored in any combination of databases (e.g., relational or non-relational), flat files, or other formats.

As an example of how the predictive case-solvability service 111 may operate with respect to a particular case, consider the following example. Suppose a user (e.g., an agent of the consumer entity that uses the predictive case-solvability service 111) opens a new case, creates an electronic data collection 114 that is associated with the case, and adds metadata and other digital data (e.g., files of various types, such as those described above) to the electronic data collection 114. The user may provide manual input via the user interface 126 to request that the predictive case-solvability service 111 generate an initial solvability score for the case. In response to such a request or some other trigger event (e.g., the elapsing of a predefined period of time since the creation of the electronic data collection 114), the feature extractor 122 extracts a set of features from the electronic data collection 114. The score generator 117 generates an initial solvability score based for the case for the case associated with the electronic data collection 114 based on the set of features. In one example, the score generator 117 may input the set of features into the machine-learning model 118 and the machine-learning model may output the solvability score in response. In another example, the score generator 117 may generate the solvability score by applying the features to a predetermined solvability matrix (e.g., comprising static rules that specify how much to add to or subtract from a running solvability score based on feature values).

Each time a subsequent trigger event is detected, the process may be repeated. Specifically, the feature extractor 122 can extract an updated set of features from the electronic data collection 114 and the score generator 117 can generate a current (e.g., updated) solvability score for the case associated with the electronic data collection 114 based on the updated set of features.

In order to ensure that the solvability score for the case associated with the electronic data collection 114 stays up to date, the predictive case-solvability service 111 can be configured to recognize a number of different event types as trigger events. Some examples of trigger events may include a predefined amount of time elapsing since the latest solvability score for the case was generated, a change being made to the electronic data collection 114 (e.g., new evidence is added), a change in resources or personnel who are assigned to the case, and an additional case being tagged as being related to the case. Other types of trigger events may include changes in the law. For example, a court ruling that establishes a new precedent in a case type may be a trigger event for cases of that type. In another example, a new law passed by a legislature that changes admissibility rules for a certain type of evidence may be a trigger event for cases associated with electronic data collections that include evidence of that type. In addition, changes to algorithms that are applied to evidence or in newly updated metrics that reflect on the accuracy of those algorithms may be trigger events for cases in which those algorithms can be applied to one or more types of evidence. For example, if a facial recognition algorithm applied to video data is updated and the updated algorithm is likely to produce an output with a higher degree of confidence than the previous version of the algorithm, the update to the algorithm may serve as a trigger event for cases that include evidence to which the algorithm may be applied. Similarly, if a metric (e.g., false-negative rate, false-positive rate, precision, or recall) for algorithm used to match spent shell casings to firearms is updated (e.g., in published research data), the update to the metric may serve as a trigger event for cases in which shell casings have been collected as evidence.

There are many types of features that the feature extractor 122 may extract from the electronic data collection 114. Some features, such as metrics that represent the percentage of leads that have been followed for the case associated with the electronic data collection 114 and an incident type (e.g., robbery, public disturbance, grand theft auto, trespassing, battery, assault, traffic violation, fraud, shoplifting, theft, burglary, larceny, arson, mass shooting, welfare check, etc.) for the case, may have been entered manually by a user. Other features, such as the age of a particular piece of evidence, may be calculated by the feature extractor 122 automatically based on the numeric difference between a timestamp associated with the piece of evidence and a current timestamp. Some features may even represent values that can also qualify as trigger events. For example, the amount of time since a change has been made to the electronic data collection 114 may serve as both a feature and a trigger event if the amount of time meets a predefined threshold.

Any feature that potentially correlates with case solvability may be of interest. For example, some features may represent types of evidence that have been collected for the case associated with the feature extractor 122. Various features may represent whether specific types of biological evidence (e.g., organic) or physical evidence (e.g., inorganic) have been identified and collected, such as hair samples, fiber samples, paint samples, bodily fluid samples (e.g., blood, saliva, etc.), articles of clothing, impressions (e.g., from tires, shoes, teeth, etc.), weapons (e.g., guns, knives, blunt objects, etc.), shell casings, bullets, particulate matter (e.g., dirt, sand, dust), personal effects (e.g., wallets, purses, eyeglasses, cellular phones, keys), and even bodies of victims. Other features may represent whether certain types of tests and analyses have been performed on items of physical evidence and what the results of such tests indicated. For example, some features may represent whether particular items of physical evidence (e.g., a fluid sample, a discarded bottle, a cigarette, a bone, etc.) have been tested for nuclear DNA or mitochondrial DNA and whether reports from CODIS or some other DNA database indicated that a match had been found. Some features may also represent whether certain types of spectroscopy (e.g., mass spectrometry or visible microspectrophotometry) analysis and comparison have been performed on specific items of evidence, whether blood-type testing has been performed on a particular blood sample, whether ballistics testing has been used to compare a bullet to a firearm, whether Luminol testing has been done at a potential crime scene, whether cyanoacrylate fingerprint testing has been performed on an item, whether a forensic genealogical analysis has been done on a DNA sample to identify possible relatives of a suspect, whether any items have been tested for microorganisms (e.g., diatoms, fungus, or bacteria) that could link a suspect to a victim or a crime scene, whether dental impressions have been collected from a suspect and compared to bite impressions found on items of physical evidence (e.g., discarded gum), whether gas chromatography has been used to test an item for a chemical accelerant (e.g., if arson is suspected), whether timely breathalyzer tests were performed, or whether toxicology tests for have been performed (e.g., testing the ashes of a cremated person for arsenic or a heavy metal such as mercury or thallium; testing a person's blood for ethylene glycol, succinylcholine, or metabolites thereof; testing hair to establish a timeline for when poisoning occurred; etc.). Other features may represent whether certain types of media data are present in the electronic data collection 114 and to what extent those media data depict persons or objects of interest. Such media data may include video data (e.g., digital footage from dashboard cameras, body cameras, security cameras, or smartphone cameras), audio data (e.g., digital audio recordings from 9-1-1 calls, undercover telephone conversations recorded via wiretapping, and voice and environmental recordings from push-to-talk (PTT) sessions and PTT over cellular (PoC) sessions that may capture background sounds that may serve as evidence in addition to voices), and image data (e.g., digital photos of crime scenes, digital photos of items of physical evidence collected from crime scenes and via search warrants, autopsy photos, mug shots, and fingerprint images). Additional features may represent whether certain types of textual data are present in the electronic data collection 114 and to what extent the textual data describe persons or objects of interest. Such textual data may include, for example, transcriptions of audio conversations, descriptions of physical evidence, transcriptions of video data, incident reports, witness statements, receipts (e.g., showing when and where items of interest were purchased or repaired), timecards from employers of persons of interest, medical records, and email correspondence. There may also be features that represent cellular phone records (e.g., when calls were made from a cellular phone of interest and the cellular towers through which the calls were routed), scan records for door-access badges, toll road records (e.g., showing when vehicles of interest passed through specific toll booths), and other types of records.

Also, some features may represent outcomes resulting from the incident, such as the number of deaths, the number of injuries resulting in hospitalization, the number of responders dispatched to the incident, the duration of the incident, and the population density of the area where the event occurred (which may serve as a proxy estimate of the number of witnesses to the incident). Other outcomes that may take longer to determine, such as whether the incident was mentioned in traditional media (e.g., traditional media such as newspapers or news broadcasts) or social media (e.g., postings on social networking sites), may also be used as features when available.

Other features could represent the time of day that the incident occurred (e.g., morning, afternoon, night, or the hour of the day), the day of the week on which the incident occurred, the month in which the incident occurred, and whether the incident occurred on a holiday. Other features could represent a location where the incident took place (e.g., an address, a zip code, global positioning system (GPS) coordinates, a city, a county, etc.). Still another feature could represent a currency value associated with property involved in the incident (e.g., the value of a chattel that was stolen, the amount of damage that was done to real property or automobiles involved in the incident, etc.). Additional features could represent the number of known suspects, whether the known suspects are repeat offenders, whether the suspects were on parole at the time of the incident, and whether the suspects have any known affiliations with criminal entities (e.g., the mafia, a street gang, a drug-trafficking cartel, or a terrorist group). In addition, solvability-score trends that are detected by the trend detector 123 (e.g., as described in greater detail below) may also serve as features for the cases in which those trends were detected. Thus, any trends in the solvability score of a case may, like other features, influence a current solvability score for the case.

Persons of skill in the art will understand that feature values may be digitally represented a variety of ways. For example, a feature may be represented by an integer, a real number (e.g., decimal), an alphanumeric character, or a string. Features may also be discretized, normalized (e.g., converted to a scale from zero to one), or preprocessed in other ways to facilitate compatibility with the machine-learning model 118. The manner in which the score generator 117 uses the features to generate the solvability score may vary depending on whether a solvability matrix is used or whether the machine-learning model 118 is used. However, even if the machine-learning model 118 is not used by the score generator 117 to generate solvability scores, the recommendation engine 125 may still leverage the machine-learning model 118 to identify actions to recommend for increasing the solvability score for a case.

There are many different types of inductive machine-learning models that can be used for the machine-learning model 118. Neural networks, support vector machines, Bayesian belief networks, association-rule models, decision trees, nearest-neighbor models (e.g., k-NN), regression models, deep belief networks, and Q-learning models are a few examples of model types that may be used. In addition, ensemble machine-learning models can be constructed from combinations of individual machine-learning models. Ensemble machine-learning models may be homogenous (i.e., including multiple member models of the same type) or non-homogenous (i.e., including multiple member models of different types). Within an ensemble machine-learning model, the member machine-learning models may all be trained using the same training data or may be trained using overlapping or non-overlapping subsets randomly selected from a larger set of training data. The Random-Forest model, for example, is an ensemble model in which multiple decision trees are generated using randomized subsets of input features and randomized subsets of training instances.

In order to ensure that the machine-learning model 118 is updated to reflect current trends in case solvability data, the predictive case-solvability service 111 uses the training engine 121 to update the training data 119 and to retrain the machine-learning model 118 on a regular basis as the training data is updated. The following examples illustrate how the training data 119 may be generated and updated.

In one example, suppose the electronic data collection 114 is updated to reflect that the associated case has been labeled as solved. The predictive case-solvability service 111 triggers the training engine 121 to create a new training instance to represent the case. In response, the training engine 121 signals the feature extractor 122 to extract a set of features for the electronic data collection 114. Upon receiving the extracted features from the feature extractor 122, the training engine 121 creates a training instance 114b. The training instance 114b comprises the features extracted for the electronic data collection 114 and also comprises a label that indicates the case associated with the electronic data collection 114 has been solved. The label may be, for example, an upper-bound value for the solvability score that is only assigned to cases that have been verified as solved. The training instance 114b is then added to the training data 119. Other training instances can be added to the training data 119 in a similar manner when other electronic data collections (e.g., in the electronic data collections 127) are updated to reflect that the cases associated therewith have been labeled as solved.

In addition, the training engine 121 can create training instances based on electronic data collections that are associated with cases that remain labeled as unsolved after a predefined amount of time has elapsed since those electronic data collections were created (e.g., three years). These training instances are also created using features extracted by the feature extractor 122, but their labels may be current solvability scores for the associated cases (e.g., values that are less than the upper-bound value for solvability scores). When the associated case is solved, a training instance generated based on the electronic data collection for the case before the case was solved may, in some examples, be rendered obsolete. The training engine 121 may therefore remove the obsolete training instance from the training data 119 and add a new training instance with an updated label (e.g., as described above with respect to the electronic data collection 114 when the associated case is labeled as solved).

Since the training engine 121 will be creating and updating training instances frequently in the manner described above as the electronic data collections 127 are updated and the cases associated therewith are solved (or remain unsolved after a threshold period of time), the set of training instances in the training data 119 changes over time. When the set of training instances is changed by at least a threshold quantity (e.g., percentage or number) of training instances, the training engine 121 retrains the machine-learning model 118. This change in the threshold quantity of training instances in the training data 119 can also serve as a trigger event that triggers the predictive case-solvability service 111 to generate updated solvability scores for unsolved cases that are associated with the electronic data collections 127 (e.g., in the manner described above for generating the current solvability score for a case associated with the electronic data collection 114).

The predictive case-solvability service 111 may further include a trend detector 123 that is configured to detect solvability-score trends in a series of solvability scores generated for the case associated with the electronic data collection 114 over time. Many types of trends may be detected. For example, suppose the machine-learning model 118 outputs a current solvability score for the case associated with the electronic data collection 114 after receiving a set of features extracted by the feature extractor 122 in response to a trigger event. Furthermore, suppose that the current solvability score is the latest in a series of solvability scores that have been generated for the case over time in response to previous trigger events. Also suppose that the current solvability score causes a condition to be satisfied and that, in this example, the condition is that a solvability-score trend can be detected in the series once the current solvability score has been appended to the series. Upon detecting the trend, the trend detector 123 signals the recommendation engine 125 to identify an action to be performed in order to influence to solvability-score trend in a manner that will increase the probability of the case being solved. If the recommendation engine 125 cannot identify an action that is likely to increase the probability of the case being solved, the recommendation engine 125 may instead recommend an action that would be beneficial for some other reason (e.g., the action may be to reassign resources that are devoted to the case to another case that is more likely to be solvable). A graph that illustrates the solvability score trend (e.g., by plotting the solvability scores in the series against time) can be rendered in the user interface 126. In addition, a message that recommends the action be performed can also be presented in the interface. The trend detector 123 may also cause an indication of the detected trend to be added to the electronic data collection 114 such that the feature extractor 122 may generate one or more features that reflect the detected trend and a time when the trend was detected.

There are many types of trends that the trend detector 123 may detect and, depending on the specific trend detected, there are a number of approaches that the recommendation engine 125 may apply to identify an action to recommend based on the detected trend. One type of trend that may be detected, for example, is whether the current solvability score meets a predefined threshold value. Another type of trend that may be detected is whether the numeric difference between the current solvability score and an immediately prior solvability score for the case meets a predefined threshold value. Other trends that may be detected are whether the solvability scores in the series have been monotonically non-increasing, monotonically decreasing, monotonically non-decreasing, or monotonically increasing for the most recent N solvability scores in the series (where N is a positive integer). In addition, trends in rates of change of the solvability score may be detected. For example, the trend detector may detect when a first derivative of a curve (e.g., a Legrange polynomial, a cubic spline, or a regression curve) that fits (e.g., interpolates) the solvability scores in the series has been decreasing (or, in another example, increasing) for the most recent N solvability scores in the series or when a second derivative of the curve becomes negative (i.e., when a point of inflection occurs in the curve, thereby indicating that a rate of decrease of the curve is increasing).

There are also many different ways that the recommendation engine 125 may identify an action to recommend based on the detected trend (or other satisfied condition). For example, suppose the features extracted from the electronic data collection 114 indicate that the associated case has a particular incident type and that a first type of evidence is present in the electronic data collection 114. The recommendation engine 125 may identify training instances in the training data 119 that represent cases that have been labeled as solved. Amongst those identified training instances, the recommendation engine 125 can determine whether there is a correlation between a feature that indicates the first type of evidence is present and another feature that indicates a second type of evidence is present. As will be recognized by persons of skill in the art, such a correlation may measured by, for example, a Pearson Correlation coefficient if the features are numeric, a tetrachoric correlation coefficient if the features are binary, a polychoric correlation coefficient if the features are ordinal and categorical, or a Cramer's V coefficient if the features are nominal and categorical. If the second type of evidence is correlated with the first type of evidence in the identified training instances (which are labeled as solved) and the second type of evidence is not found in the electronic data collection 114, the action suggested by the recommendation engine 125 may be to obtain the second type of evidence for the case associated with the electronic data collection 114. Suppose, for example, that the incident type is “grand theft auto” and the first type of evidence is a recovered vehicle. If the recommendation engine 125 detects that the presence of a recovered vehicle (the first type of evidence) is correlated with the presence of fingerprints (the second type of evidence) in “grand theft auto” cases that have been solved, the recommendation engine 125 may recommend that the recovered vehicle be examined for fingerprints. In another example, suppose that the incident type is “burglary” and the first type of evidence is a discarded cigarette butt. If the recommendation engine 125 detects that the presence of discarded cigarette butts (the first type of evidence) are correlated with the presence of DNA profiles in “burglary” cases that have been solved, the recommendation engine 125 may recommend that the cigarette butt be sent to a lab so that a DNA profile can be extracted therefrom.

In another example, the recommendation engine 125 may leverage the machine-learning model 118 to identify an action to recommend based on the detected trend (or other satisfied condition). Suppose, for example, that the machine-learning model 118 is a nearest-neighbor model that identifies the K training instances (where K is a positive integer) in the training data 119 that are the nearest neighbors of the feature set extracted from the electronic data collection 114 (e.g., the K training instances have feature values that are more similar to the feature values extracted from the electronic data collection 114 than the remainder of the training instances found in the training data 119). In this example, due to the nature of nearest neighbor models generally, the machine-learning model 118 will identify the K nearest neighbors automatically based on a distance function (e.g., Euclidean distance, Manhattan distance, Minkowski distance, or Hamming distance) during the process of generating a solvability score. In one example, the distance function applied by the machine-learning model 118 may use a modified distance function that includes individualized weights for different features that are deemed to be more meaningful. Specifically, the distance function may be:

$${\sum }_{i = 1}^{j} \frac{1}{{w}_{i}} \vert {x}_{i} - {y}_{i} \vert ,$$

where j is the number of features (which should be a positive integer), wᵢ is the weight assigned to the ith feature, xᵢ is the value (i.e., actual parameter) of the feature for the input instance (i.e., the feature set extracted from the electronic data collection 114) and yᵢ is the value (i.e., actual parameter) of the feature for the training instance in the training data 119 for which a distance to the input instance is being calculated. In this example, larger weights result in smaller distances—and training instances with smaller distances to the input instance are more likely to be selected as the nearest neighbors of the input instance. Features that represent detected trends may have relatively large weights (e.g., greater than 1), while a feature that represents the time since a solvability score was last generated for a corresponding case may have a relatively small weight (e.g., less than 1). The result of giving high weights to trend-based features and low weights to the time-score-generated feature would be to bias the machine-learning model 118 toward selecting training instances that represent recent cases with similar trends as the nearest neighbors of the input instance.

Regardless of which distance function is used, however, the recommendation engine 125 may identify a subset of the K nearest neighbors that have been labeled as solved. Out of that subset, the recommendation engine 125 may identify one or more features that indicate one or more types of evidence are found in solved cases represented by the training instances in the subset. If any of the one or more types of evidence identified are not found in the electronic data collection 114, the recommendation engine 125 may recommend that those types of evidence be obtained for the associated case.

In another example, suppose the machine-learning model 118 is a decision tree. In this example, suppose the input instance (i.e., the feature set extracted from the electronic data collection 114) leads to a particular leaf node (which assigns the current solvability value for the input instance) in the decision tree. The recommendation engine 125 may move to the nearest internal (i.e., inner) node of the decision tree and determine whether there is an additional leaf node that would assign the upper-bound solvability score value in the subtree rooted at the nearest internal node. If so, the recommendation engine 125 engine identifies a feature that, if changed in the input instance, would have caused the input instance to lead to the additional node and recommends an action that would cause the feature to be changed accordingly. If no such additional leaf node is found in the subtree rooted at the nearest internal node, the recommendation engine 125 can move up one level to next interior node through which the decision path for the input instance passes and repeat the process on a subtree that is rooted at the next interior node.

In another example, suppose the machine-learning model 118 is a neural network. In this example, the recommendation engine 125 may apply a single-generation genetic algorithm to find a change in a feature value that would result in an increase in solvability score. Specifically, the recommendation engine 125 may generate a plurality of variant instances based on the input instance. Each variant instance may be identical to the input instance except with respect to the value of a single respective feature that is ‘mutated’ (e.g., changed). The recommendation engine 125 may then use the machine-learning model 118 to generate solvability scores for the variant instances and select the variant instance that yielded an upper-bound increase in the solvability score relative to the solvability score for the input instance. The recommendation engine 125 then recommends an action that corresponds to the feature-value change that was made in the selected variant instance.

Persons of skill in the art will recognize that the recommendation engine 125 may use other approaches to leverage the machine-learning model 118 to identify an action to recommend without departing from the spirit and scope of this disclosure.

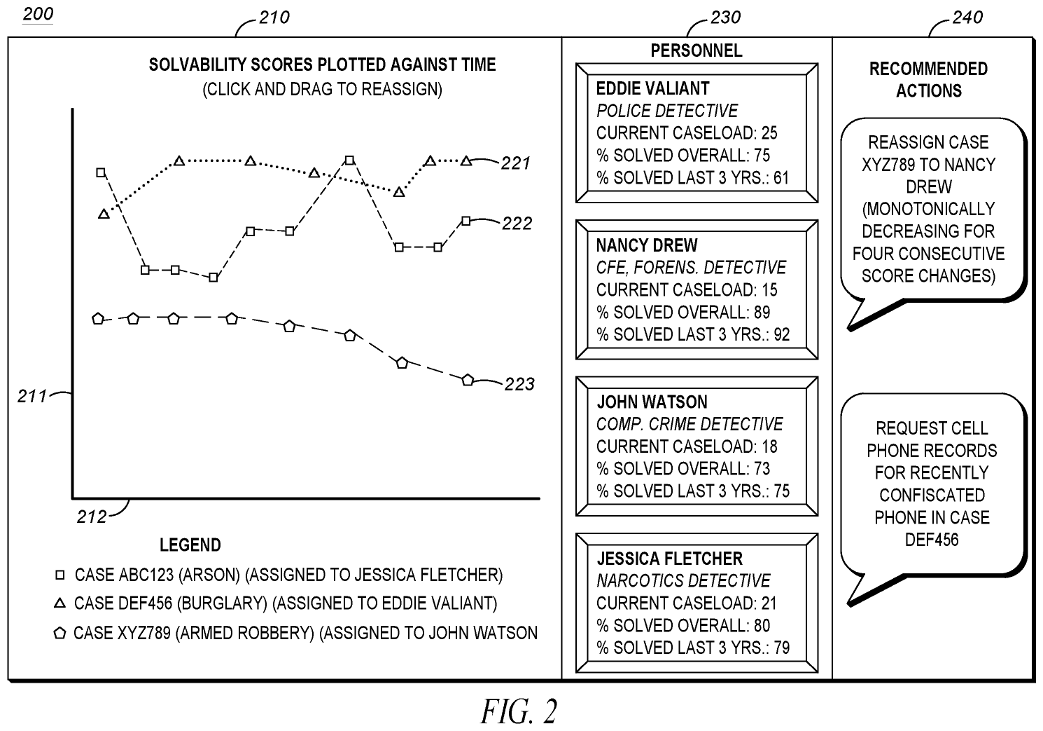

FIG. 2 illustrates one example of how a user interface (e.g., such as the user interface 126 described in FIG. 1) for systems described herein may appear on an electronic display, according to one example. Persons of skill in the art will recognize that other user interface designs and schemes may be used without departing from the spirit and scope of this disclosure.

The user interface 200 includes a graphical display area 210. Within the graphical display area 210, a vertical axis 211 represents a solvability-score dimension and a horizontal axis 212 represents a time dimension. In the example shown, three series of solvability scores generated for three respective cases are plotted against time. Specifically, series 221 represents the solvability scores for a first case, series 222 represents the solvability scores for a second case, and series 223 represents the solvability scores for a third case. The markers for the series 221, the series 222, and the series 223, respectively, are shown as being connected via a linear interpolation technique, but persons of skill in the art will understand that other interpolation techniques (or regression techniques) may be used without departing from the spirit and scope of this disclosure. Regardless of which interpolation technique is used, however, plotting solvability scores in the manner shown illustrates solvability-score trends in an intuitive fashion.

As shown, the sidebar 230 lists the names of personnel to whom cases are or can be assigned, certifications (e.g., certified fraud examiner (CFE)), areas of focus/expertise (e.g., narcotics, forensics, computer crime, etc.) and some metrics for those personnel (e.g., current caseload, percentage of cases solved overall, and percentage of cases solved in the last three years). In addition, the sidebar 240 presents messages that recommend actions. For example, one recommended action is that the third case (which corresponds to series 223) be reassigned from Eddie Valiant to Nancy Drew. This recommendation may have been generated in response to a condition being satisfied by the most recent solvability score in the series 223 (e.g., the last four solvability scores in the series 221 have been monotonically decreasing). In one example, the user interface 200 may allow a user to accomplish the recommended action by placing a cursor over the series 223, clicking on the series 223, and dragging to the tile labeled “Nancy Drew.” An action recommended for the second case (which corresponds to series 222), as shown in the sidebar 240, it to request cellular phone records from a wireless provider for a phone confiscated from a suspect. This action may have been recommended for the second case in response to the most recent solvability score in the series 222 satisfying a condition (e.g., being greater than or equal to a threshold score).

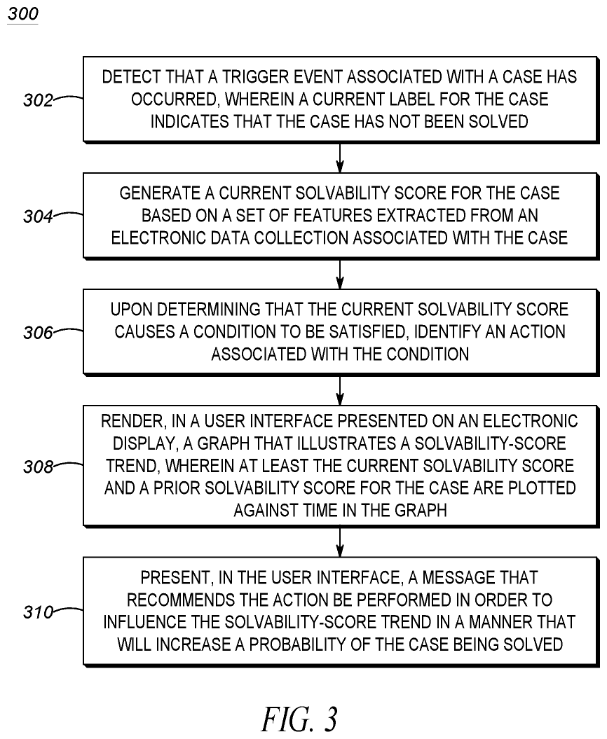

FIG. 3 illustrates functionality 300 for a predictive case-solvability service, according to one example. The functionality 300 does not have to be performed in the exact sequence shown. Also, various blocks may be performed in parallel rather than in sequence. Accordingly, the elements of the functionality 300 are referred to herein as “blocks” rather than “steps.” The functionality 300 can be executed as instructions on a machine (e.g., by one or more processors), where the instructions are stored on a transitory or non-transitory computer-readable storage medium. While only five blocks are shown in the functionality 300, the functionality 300 may comprise other actions described herein. Also, in some examples, some of the blocks shown in the functionality 300 may be omitted without departing from the spirit and scope of this disclosure.

As shown in block 302, the functionality 300 includes detecting that a trigger event associated with a case has occurred, wherein a current label for the case indicates that the case has not been solved.

As shown in block 304, the functionality 300 includes generating a current solvability score for the case based on a set of features extracted from an electronic data collection associated with the case. For example, the set of features may be provided as input into a machine-learning model to generate a current solvability score for the case. In another example, the set of features may be compared to a solvability matrix that specifies an amount to add to the solvability score for each feature value.

As shown in block 306, the functionality 300 includes, upon determining that the current solvability score causes a condition to be satisfied, identifying an action associated with the condition. The action may be associated with the condition, for example, via a machine-learning model (e.g., as described above with respect to the operation of the score generator 117 in FIG. 1).

As shown in block 308, the functionality 300 includes rendering, in a user interface presented on an electronic display, a graph that illustrates a solvability-score trend, wherein at least the current solvability score and a prior solvability score for the case are plotted against time in the graph.

As shown in block 310, the functionality 300 includes presenting, in the user interface, a message that recommends the action be performed in order to influence the solvability-score trend in a manner that will increase a probability of the case being solved.

Many different types of trigger events may be detected. The trigger event may comprise, for example, an addition of evidence to the electronic data collection. The trigger event may also be that a predefined amount of time has elapsed since the prior solvability score was generated. The trigger event may also be that an additional case has been tagged as being related to the case (since the additional case may include additional evidence that is pertinent to the case). In another example, the trigger event may comprise detecting that a set of training instances used to train the machine learning model has been changed by at least a threshold quantity of training instances since the prior solvability score for the case was generated.

The current solvability score may cause many different types of conditions may be satisfied. For example, one condition may be that the current solvability score meets a predefined threshold value. Another condition may be that the difference between the prior solvability score and the current solvability score meets a threshold value. Another condition may be that a series of N solvability scores determined for the case has been monotonically non-increasing, wherein N is a positive integer, the prior solvability score is a penultimate solvability score in the series, and the current solvability score is an Nth solvability score in the series.

Depending on the nature of the condition that is satisfied, there are many different types of actions that may be associated with the condition and, if performed, may influence the solvability-score trend. For example, the action may comprise adding a specific type of evidence to the electronic data collection, reassigning the case to an agent other than the agent to whom the case is currently assigned, or changing a priority level assigned to the case. In examples in which a machine-learning model is used for identifying the recommended action, a trigger event or a condition satisfied thereby may be indicated by one or more of the features that the machine-learning model uses as input.

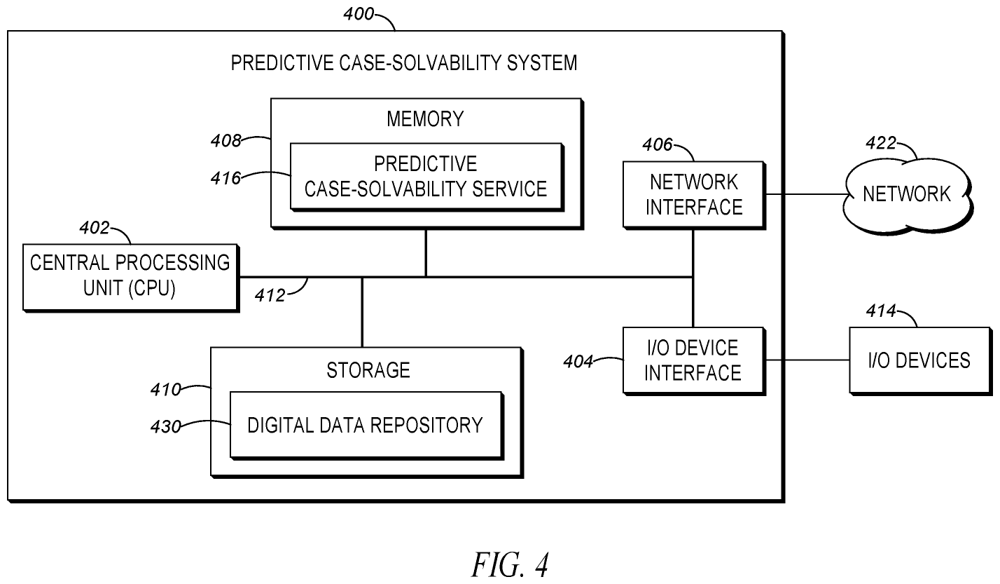

FIG. 4 illustrates a predictive case-solvability system 400 that generates solvability scores when trigger events are detected, identifies actions to recommend when solvability scores cause conditions to be satisfied, and updates a machine-learning model used to generate solvability scores, according to one example. As shown, the predictive case-solvability system 400 comprises a central processing unit (CPU) 402 and an input/output (I/O) device interface 404 that allows I/O devices 414 (e.g., a keyboard, a mouse, or a touch screen) to be connected to the predictive case-solvability system 400. The predictive case-solvability system 400 also comprises a network interface 406 that connects the predictive case-solvability system 400 to the network 422, a memory 408, storage 410, and an interconnect 412 (e.g., a common data and address bus).

The CPU 402 may retrieve application data and programming instructions from the memory 408 and execute those programming instructions. The interconnect 412 provides a digital transmission path through which the CPU 402, the I/O device interface 404, the network interface 406, the memory 408, and the storage 410 can transmit data and programming instructions amongst each other. While the CPU 402 is shown as a single block, persons of skill on the art will understand that the CPU may represent a single CPU, a plurality of CPUs, a CPU with a plurality of processing cores, or some other combination of processor hardware.

The memory 408 may be random access memory (RAM) and the storage 410 may be non-volatile storage. Persons of skill in the art will understand that the storage 410 may comprise any combination of internal or external storage devices (e.g., disc drives, removable memory cards or optical storage, solid state drives (SSDs), network attached storage (NAS), or a storage area-network (SAN)). The digital data repository 430 may be located in the storage 410.

As shown, the predictive case-solvability service 416 may be stored in the memory 408 and may function as described with respect to FIGS. 1-3 (e.g., by generating solvability scores when trigger events are detected, identifying actions to recommend when solvability scores cause conditions to be satisfied, updating a machine-learning model that can be used to determine one or both of solvability scores and actions to recommend, and presenting solvability-score trends and recommended actions in a graphical interface that allows at least some of the recommended actions to be preformed therethrough).

Examples are herein described with reference to flowchart illustrations and/or block diagrams of methods, apparatuses (e.g., systems), and computer program products. Persons of skill in the art will understand that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein do not, in some examples, have to be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot render graphs on an electronic display, among other features and functions set forth herein).

In the foregoing specification, specific examples have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The claimed matter is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting example the term is defined to be within 10%, in another example within 5%, in another example within 1%, and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

It will be appreciated that some examples may comprise of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and Integrated Circuits (ICs) with minimal experimentation. For example, computer program code for carrying out operations of various examples may be written in an object oriented programming language such as Java, Smalltalk, C++, Python, or the like. However, the computer program code for carrying out operations of various examples may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

Examples are herein described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

What is claimed is:

1. A method comprising:
detecting that a trigger event associated with a case has occurred, wherein a current label for the case indicates that the case has not been solved;
generating a current solvability score for the case based on a set of features extracted from an electronic data collection associated with the case;
upon determining that the current solvability score causes a condition to be satisfied, identifying an action associated with the condition;
rendering, in a user interface presented on an electronic display, a graph that illustrates a solvability-score trend, wherein at least the current solvability score and a prior solvability score for the case are plotted against time in the graph; and
presenting, in the user interface, a message that recommends the action be performed in order to influence the solvability-score trend in a manner that will increase a probability of the case being solved.

2. The method of claim 1, wherein the action comprises adding a specific type of evidence to the electronic data collection.

3. The method of claim 1, wherein the trigger event is that a predefined amount of time has elapsed since the prior solvability score was generated.

4. The method of claim 1, wherein the condition is that the current solvability score meets a predefined threshold value.

5. The method of claim 1, wherein the condition is that a difference between the prior solvability score and the current solvability score meets a predefined threshold value.

6. The method of claim 1, wherein the condition is that a series of N solvability scores determined for the case has been monotonically non-increasing, wherein N is a positive integer, the prior solvability score is a penultimate solvability score in the series, and the current solvability score is an Nth solvability score in the series.

7. The method of claim 1, wherein the trigger event comprises detecting that a set of training instances used to train a machine-learning model used to generate the prior solvability score has been changed by at least a threshold quantity of training instances since the prior solvability score for the case was generated.

8. A non-transitory computer-readable storage medium containing instructions that, when executed by one or more processors, perform a set of actions comprising:
detecting that a trigger event associated with a case has occurred, wherein a current label for the case indicates that the case has not been solved;
generating a current solvability score for the case based on a set of features extracted from an electronic data collection associated with the case;
upon determining that the current solvability score causes a condition to be satisfied, identifying an action associated with the condition;
rendering, in a user interface presented on an electronic display, a graph that illustrates a solvability-score trend, wherein at least the current solvability score and a prior solvability score for the case are plotted against time in the graph; and
presenting, in the user interface, a message that recommends the action be performed in order to influence the solvability-score trend in a manner that will increase a probability of the case being solved.

9. The non-transitory computer-readable storage medium of claim 8, wherein the action comprises adding a specific type of evidence to the electronic data collection.

10. The non-transitory computer-readable storage medium of claim 8, wherein the trigger event is that a predefined amount of time has elapsed since the prior solvability score was generated.

11. The non-transitory computer-readable storage medium of claim 8, wherein the condition is that the current solvability score meets a predefined threshold value.

12. The non-transitory computer-readable storage medium of claim 8, wherein the condition is that a difference between the prior solvability score and the current solvability score meets a predefined threshold value.

13. The non-transitory computer-readable storage medium of claim 8, wherein the condition is that a series of N solvability scores determined for the case has been monotonically non-increasing, wherein N is a positive integer, the prior solvability score is a penultimate solvability score in the series, and the current solvability score is an Nth solvability score in the series.

14. The non-transitory computer-readable storage medium of claim 8, wherein the trigger event comprises detecting that a set of training instances used to train a machine-learning model used to generate the prior solvability score has been changed by at least a threshold quantity of training instances since the prior solvability score for the case was generated.

15. A system comprising:
one or more processors; and
a memory containing instructions thereon which, when executed by the one or more processors, cause the processors to perform a set of actions comprising:
detecting that a trigger event associated with a case has occurred, wherein a current label for the case indicates that the case has not been solved;
generating a current solvability score for the case based on a set of features extracted from an electronic data collection associated with the case;
upon determining that the current solvability score causes a condition to be satisfied, identifying an action associated with the condition;
rendering, in a user interface presented on an electronic display, a graph that illustrates a solvability-score trend, wherein at least the current solvability score and a prior solvability score for the case are plotted against time in the graph; and
presenting, in the user interface, a message that recommends the action be performed in order to influence the solvability-score trend in a manner that will increase a probability of the case being solved.

16. The system of claim 15, wherein the action comprises adding a specific type of evidence to the electronic data collection.

17. The system of claim 15, wherein the trigger event is that a predefined amount of time has elapsed since the prior solvability score was generated.

18. The system of claim 15, wherein the condition is that the current solvability score meets a predefined threshold value.

19. The system of claim 15, wherein the condition is that a difference between the prior solvability score and the current solvability score meets a predefined threshold value.

20. The system of claim 15, wherein the condition is that a series of N solvability scores determined for the case has been monotonically non-increasing, wherein N is a positive integer, the prior solvability score is a penultimate solvability score in the series, and the current solvability score is an Nth solvability score in the series.
